(19) United States
(12) Patent Application Publication
(10) Pub. No.: US 2007/0205581 A1
(43) Pub. Date: Sep. 6, 2007

(54) Trailer hitch positioning device

(76) Inventor: Charles Wilcox, Hot Springs, SD (US)

Correspondence Address: Gene R. Woodle, 3516 Woodle Drive, Rapid City, SD, 57702, US

(21) Appl. No.: 11/370,106

(22) Filed: Mar. 6, 2006

(51) Int. Cl. B60D 1/36

(52) U.S. Cl. 280/477

(57) ABSTRACT

A trailer hitch positioning device is disclosed which aids an operator in properly positioning a vehicle to attach the vehicle to a trailer. By aligning a trailer indicator on the trailer and a vehicle indicator in the rear window of the vehicle in the rearview mirror of the vehicle, an operator can insure that the vehicle trailer hitch is properly positioned to affix the trailer hitch to the trailer.

### BACKGROUND OF THE INVENTION

1. Field of the Invention

The present invention relates generally to trailer hitches and more specifically to a device for easily positioning a trailer hitch for attachment to a trailer.

2. Background Information

Every day thousands of vehicles are attached to thousands of trailers. Contractors attach equipment trailers to pickups and boaters affix boat trailers to SUV's. Most commonly a trailer hitch is attached to the vehicle and protrudes rearward from the vicinity of the middle of the rear bumper. Ordinarily, a ball is affixed to the rear of the trailer hitch by a stem such that it protrudes upward from the rear of the trailer hitch. The trailer has some form of tongue which protrudes forward from the trailer. The forward end of the tongue includes a hitch socket which fits over the ball on the trailer hitch to removably affix the trailer to the vehicle. Often a trailer jack is also affixed to the tongue which serves to hold the tongue off the ground when the trailer is not affixed to a vehicle.

In order to affix the trailer to a vehicle, the tongue is positioned such that the hitch socket is positioned slightly higher than the top of the hitch ball. The vehicle is backed up until the ball is directly beneath the hitch socket and the trailer tongue lowered until the hitch socket fits over the hitch ball. Because the operator of the vehicle is rarely able to see either the hitch ball or the hitch socket, backing a vehicle to position a trailer hitch is often a very frustrating experience. Usually a second person who is outside the vehicle is necessary to direct the operator while backing the vehicle toward the trailer. In addition to being frustrating, backing a vehicle for positioning to affix a trailer can cause damage to the vehicle or the trailer if the vehicle bangs into the trailer tongue.

Dozens of devices have been invented to help a sole operator to back up a vehicle to a trailer and properly position the vehicle for the attachment of the trailer. The patent to Ford et al. (U.S. Pat. No. 6,923.463; Aug. 2, 2005) discloses one such device. The device includes a mirror affixed to a trailer by means of a mast. The mirror is positioned so that the operator can look out the back window of the vehicle and see the hitch socket and the hitch ball in the mirror. The patent to Wells (U.S. Pat. No. 5,970,619; Oct. 26, 1999) discloses a device which includes an activating ball which is affixed to the rear of the vehicle at a point in the operator's field of view and above the hitch ball. An alignment indicator is affixed to the trailer at a point above the hitch socket at the same height as the activating ball. The vehicle is backed until the activating ball contacts the alignment indicator. The patent to Piper et al. (U.S. Pat. No. 6,886,847; May 3, 2005) discloses a device which uses reflected acoustic signals to monitor changes in the relative position of the hitch ball and the hitch socket.

The trailer hitch positioning device of the instant invention is believed to solve, in a simple and unique fashion, problems relating to the proper positioning of a vehicle trailer hitch relative to the hitch socket on a trailer by providing a positioning device which aids the operator of the vehicle in positioning the trailer hitch properly relative to the trailer both from side to side and forward and rearward.

The ideal trailer hitch positioning device should provide a method for a single operator to properly position the trailer hitch on a vehicle for attachment to the hitch socket on a trailer. The ideal trailer hitch positioning device should provide for proper alignment of the hitch ball and the hitch socket both from side to side and forward and rearward. The ideal trailer hitch device should also operate without requiring electricity or other power. The ideal trailer hitch positioning device should also be inexpensive, rugged, and easy to use.

### SUMMARY OF THE INVENTION

The trailer hitch positioning device of the instant invention is a device with two components which may be removably affixed the rear window of a vehicle and to the front of a trailer and used to properly position the ball of a trailer hitch for attachment to the trailer socket of a trailer.

The instant invention must be “calibrated” the first time it is used. The vehicle is backed up to the trailer such that it is in the proper position for affixing the hitch ball on the vehicle to the hitch socket on the trailer. This position will nearly always be with the hitch socket just above the hitch ball. Most often the tongue of the trailer will be held at the appropriate height by adjustment of the trailer jack. After the vehicle is in position, the operator assumes a comfortable driving position in which the some portion of the trailer (or, if necessary, an item on the trailer) is in the operator's view in the rearview mirror of the vehicle through the rear window of the vehicle. A trailer indicator which is just some type of visual mark is placed on the trailer somewhere near the middle of the field of view of the operator through the rearview mirror. A vehicle indicator is affixed to the rear window of the vehicle such that the vehicle indicator is directly aligned with the trailer indicator when the operator looks in the rearview mirror. The device is thus calibrated.

After the device has been calibrated, the operator may always exactly position the hitch ball relative to the trailer hitch socket by backing the vehicle such that the vehicle indicator is exactly aligned with the trailer indicator. The side to side movement of the vehicle is controlled by comparing the apparent side to side movement of the vehicle indicator relative to the trailer indicator and the forward and rearward movement of the vehicle is controlled by comparing the apparent up and down movement of the vehicle indicator relative to the trailer indicator. When the operator sees in the rearview mirror that the vehicle indicator is exactly aligned with the trailer indicator, the hitch ball is properly positioned beneath the hitch socket. The trailer may then be attached to the vehicle in the normal fashion.

One of the major objects of the present invention is to provide a method for a single operator to properly position the trailer hitch on a vehicle for attachment to the hitch socket on a trailer.

Another objective of the present invention is to provide for proper alignment of the hitch ball and the hitch socket both from side to side and forward and rearward.

Another objective of the present invention is to operate without requiring electricity or other power.

Another objective of the present invention is to provide a device which is inexpensive, rugged, and easy to use.

These and other features of the invention will become apparent when taken in consideration with the following detailed description and the drawings.

### BRIEF DESCRIPTION OF THE DRAWINGS

FIG. 1 is a side view of a typical vehicle and trailer properly positioned for attachment of the hitch ball to the hitch socket incorporating the instant invention;

FIG. 2 is a representation of the operator's view in the rearview mirror of the vehicle showing the device of the instant invention when the vehicle and the trailer are properly positioned to affix the trailer to the vehicle;

FIG. 3 is a representation of the operator's view in the review mirror of the vehicle showing the device of the instant invention in a typical instance when the vehicle and the trailer are not properly positioned to affix the trailer to the vehicle; and

FIG. 4 shows a second embodiment of the instant invention.

### DESCRIPTION OF A PREFERRED EMBODIMENT

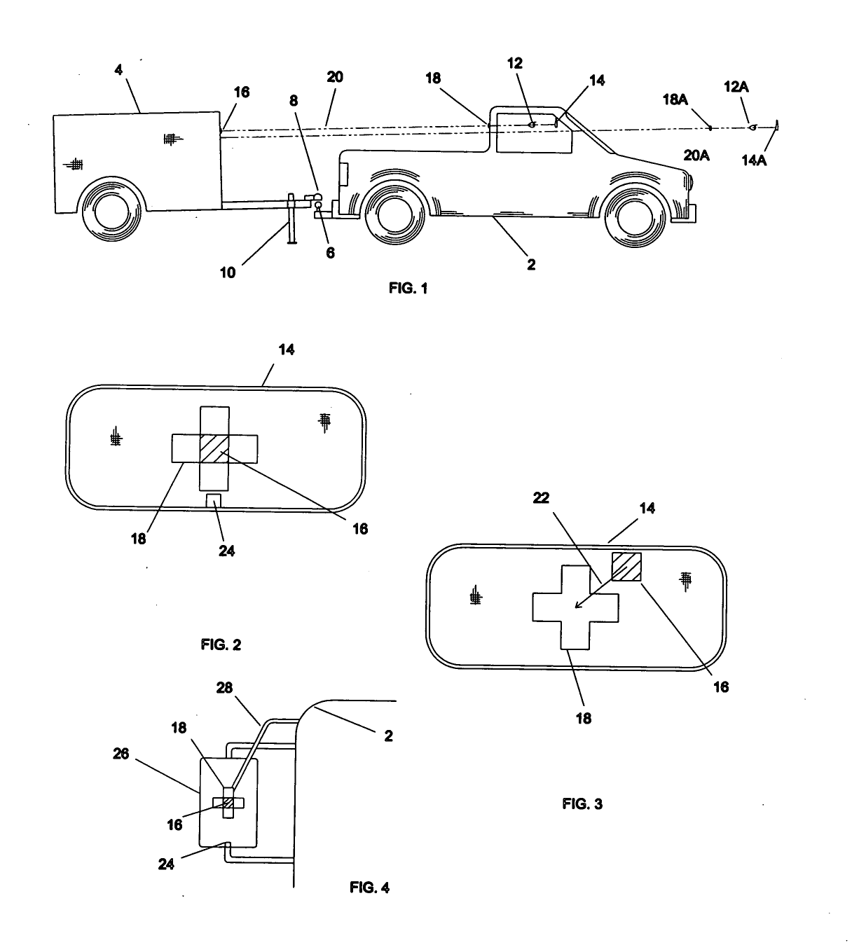

Referring to the drawings, FIGS. 1 through 3, a preferred embodiment of the trailer hitch positioning device of the instant invention is shown.

Referring now to FIG. 1, a typical vehicle 2 is shown in the proper position for attachment to a typical trailer 4. A hitch ball 6 affixed to the vehicle 2 is positioned directly beneath a hitch socket 8 on the trailer 4. The hitch socket 8 is held in this position by appropriate adjustment of a trailer jack 10 on said trailer 4. In most cases the trailer jack 10 includes a crank (not shown) for raising or lowering the front portion of said trailer 4, but any other method of holding said trailer 4 in this position may be used. All of the foregoing elements are conventional and are not considered part of the instant invention.

Still referring to FIG. 1, after said vehicle 2 and said trailer 4 are properly positioned for attachment as shown, an operator 12 sits in said vehicle 2 in a comfortable driving position and views, through the rear window of the vehicle (not shown), the forward portion of said trailer 4 in the rearview mirror 14 of said vehicle 2. A trailer indicator 16 is affixed to the forward portion of said trailer 4 such that the trailer indicator 16 is somewhere near the center of the field of view of the operator 12 in the rearview mirror 14. A vehicle indicator 18 is affixed to the rear window of said vehicle 2 such that when said operator 12 looks in said rearview mirror 14, the vehicle indicator 18 is exactly aligned with said trailer indicator 16. The line of sight of said operator 12 in said rearview mirror 14 when said trailer indicator 16 is properly aligned with said vehicle indicator 18 is indicated by line 20. It should be understood that said vehicle indicator 18 could be placed first and said trailer indicator 16 then placed on said trailer 4 such that it is aligned with said vehicle indicator. When said vehicle indicator 18 and said trailer indicator 16 are positioned as described above, the device of the instant invention may be considered calibrated. Said vehicle indicator 18 could be inside or outside said vehicle 2.

Referring now to FIG. 2, a representation of the view of said operator 12 in said rearview mirror 14 of said vehicle 2 showing the device of the instant invention when said vehicle 2 and said trailer 4 are properly positioned to affix said trailer 4 to said vehicle 2 is shown. In the preferred embodiment of the instant invention said vehicle indicator 18 has the shape of a transparent cross which is easily visible in said rearview mirror 14 when affixed to the rear window of said vehicle 2 but does not obscure the vision of said operator 12 when not in use. Said trailer indicator 16 is of such appropriate size that the image of said trailer indicator 16 in said rearview mirror 14 appears to fit exactly within the center of said vehicle indicator 18. In the preferred embodiment of the instant invention said trailer indicator 16 is a square of fluorescent material such that it shows up well in dark conditions. When said vehicle 2 is appropriately positioned relative to said trailer 4 such that said hitch socket 8 is correctly positioned directly over said hitch ball 6, the image said operator 12 sees in said rearview mirror 14 is similar to that shown in FIG. 2 with said trailer indicator 16 exactly centered within said vehicle indicator 18. It should be understood that said trailer indicator 16 and said vehicle indicator 18 could have a variety of shapes and sizes as long as it is possible to align said trailer indicator 16 and said vehicle indicator 18.

Still referring to FIG. 2, most vehicles have a switch or other device affixed to the rearview mirror. In the event that the rearview mirror is moved after the instant invention is calibrated, the operator may use the switch or other device on the rearview mirror to adjust the mirror such that said vehicle indicator 18 is in the same position as it was when the instant invention was calibrated. If said vehicle 2 does not have such a switch or other device, a mirror indicator 24 is provided which may be affixed to said rearview mirror 14. At the time the instant invention is calibrated, the mirror indicator 24 maybe affixed in a position, such as that shown, to insure that said rearview mirror 14 may always be returned to that same position by aligning said mirror indicator 24 with said vehicle indicator 18.

Referring now to FIG. 3, a representation of the view of said operator 12 in said review mirror 14 of said vehicle 2 showing the device of the instant invention in a typical instance when said vehicle 2 and said trailer 4 are not properly positioned to affix said trailer 4 to said vehicle 2 is shown. In this instance said trailer indicator 16 is not aligned with said vehicle indicator 18 as is shown in FIG. 2. Said operator 12 merely backs the vehicle, turning when necessary, such that said trailer indicator 16 moves from its current position in this figure to the alignment directly in the center of said vehicle indicator 18 as is shown in FIG. 2. The side to side movement of said vehicle 2 is controlled by referencing the apparent side to side movement of said trailer indicator 16 relative to said vehicle indicator 18 and the forward and rearward movement of said vehicle 2 is controlled by referencing the apparent up and down movement of said trailer indicator 16 relative to said vehicle indicator 18. The required movement of said trailer indicator 16 relative to said vehicle indicator 18 is shown by an arrow 22.

Referring again to FIG. 1, the apparent up and down movement of said trailer indicator 16 relative to said vehicle indicator 18 by reference to the alternate elements labeled with an “A.” The positions of said operator 12A, said vehicle indicator 18A, and said rearview mirror 14A are shown as they would be if said vehicle 2 were driven ahead a few feet. Said line 20A drawn through said operator 12A, said vehicle indicator 18A, and said rearview mirror 14A no longer intersects with said trailer indicator 16. This illustrates the cause of the apparent up and down movement of said vehicle indicator 18 relative to said trailer indicator 16.

In a second embodiment of the instant invention, the instant invention could be adapted with relative ease to operate with a vehicle using a side mirror by affixing said vehicle indicator 18 in a position other than the rear window of said vehicle 2 which allows for a direct line of sight by said operator 12 in the side mirror of said trailer indicator 16 (perhaps positioned more toward the operator 12 side of the trailer) through said vehicle indicator 18. This embodiment is illustrated in FIG. 4. In this embodiment an operator does not have a view of said trailer 4 in a rearview mirror of the vehicle, but can see the trailer in a side mirror 26. Rather than being affixed to a the rearview mirror as described above, said vehicle indicator 18 may positioned using a support 28 which is affixed to said vehicle 2 in the approximate location of the rear window described in the preferred embodiment above. Once said vehicle indicator 18 has been affixed, the instant invention is calibrated in the same manner as described above with said trailer indicator 16 being placed somewhere on said trailer 4 which allows a good view of said vehicle indicator 18 and said trailer indicator 16 in the side mirror 26. Again, said mirror indicator 24 may be affixed to said side mirror 26 to insure proper alignment of said vehicle indicator 18 and said side mirror 26.

In the preferred embodiment of the instant invention, said vehicle indicator 18 is made of clear plastic, but nearly any other material could be used provided it did not cause damage to the vehicle or obscure the vision of an operator. Said trailer indicator 16 is made from reflective tape in the preferred embodiment, but nearly anything could be used provided it was of the proper size and visible to an operator in the rearview mirror of the vehicle.

While preferred embodiments of this invention have been shown and described above, it will be apparent to those skilled in the art that various modifications may be made in these embodiments without departing from the spirit of the present invention.

I claim:

1. A trailer hitch positioning device for properly positioning a vehicle for attachment of the vehicle to a trailer where the vehicle includes a trailer hitch and the trailer includes some form of hitch socket for affixing the trailer to the trailer hitch and the vehicle includes a rearview mirror and a rear window comprising:
(1) A vehicle indicator which may be affixed to the rear window of the vehicle;
(2) A trailer indicator which may be affixed to a place on the trailer where the trailer indicator is in view of a vehicle operator in the rearview mirror of the vehicle; and
(3) The vehicle is properly positioned such that the vehicle and the trailer are in the proper position for affixing the trailer hitch to the hitch socket and the vehicle indicator and the trailer indicator affixed such that, when the operator looks in the rearview mirror of the vehicle, said vehicle indicator and said trailer indicator are exactly aligned with each other both vertically and horizontally;
whereby after the trailer hitch positioning device has been calibrated as described above, the operator may always insure that the vehicle is in proper position for affixing the trailer by positioning the vehicle such that said vehicle indicator and said trailer indicator are aligned in the rearview mirror in the same manner as when the instant invention was calibrated.

2. The trailer hitch positioning device of claim 1 in which a mirror indicator is provided which may be affixed to the rearview mirror of the vehicle at the time the instant invention is calibrated to insure that the rearview mirror is always in the same position by adjusting the rearview mirror such that the mirror indicator and said vehicle indicator are aligned as they were when the instant invention was calibrated.

3. A trailer hitch positioning device for properly positioning a vehicle for attachment of the vehicle to a trailer where the vehicle includes a trailer hitch and the trailer includes some form of hitch socket for affixing the trailer to the trailer hitch and the vehicle includes a rearview or side mirror, but does not afford an operator a view of the trailer through a rear window comprising:
(1) A vehicle indicator which may be affixed to the vehicle such that an operator may look in the mirror of the vehicle and obtain a view of the vehicle indicator and some portion of the trailer;
(2) A trailer indicator which may be affixed to a place on the trailer where the trailer indicator is in view of a vehicle operator in the mirror of the vehicle the operator may also see said vehicle indicator in the mirror; and
(3) The vehicle is properly positioned such that the vehicle and the trailer are in the proper position for affixing the trailer hitch to the hitch socket and the vehicle indicator and the trailer indicator affixed such that, when the operator looks in the mirror of the vehicle, said vehicle indicator and said trailer indicator are exactly aligned with each other both vertically and horizontally;
whereby after the trailer hitch positioning device has been calibrated as described above, the operator may always insure that the vehicle is in proper position for affixing the trailer by positioning the vehicle such that said vehicle indicator and said trailer indicator are aligned in the mirror in the same manner as when the instant invention was calibrated.

4. The trailer hitch positioning device of claim 3 in which a mirror indicator is provided which may be affixed to the mirror of the vehicle at the time the instant invention is calibrated to insure that the mirror is always in the same position by adjusting the mirror such that the mirror indicator and said vehicle indicator are aligned as they were when the instant invention was calibrated.
